(19) United States
(12) Patent Application Publication
(10) Pub. No.: US 2023/0161926 A1
(43) Pub. Date: May 25, 2023

(54) MANUFACTURING SYSTEM DESIGN VERIFICATION DEVICE

(71) Applicant: Mitsubishi Electric Corporation, Tokyo (JP)

(72) Inventors: Hiroaki INOUE, Tokyo (JP); Satoshi IWATSU, Tokyo (JP); Kohei FUJITA, Tokyo (JP)

(73) Assignee: Mitsubishi Electric Corporation, Tokyo (JP)

(21) Appl. No.: 17/916,799

(22) PCT Filed: May 15, 2020
(86) PCT No.: PCT/JP2020/019386

§ 371 Date: Oct. 4, 2022

(51) Int. Cl. G06F 30/17

(52) U.S. Cl. CPC G06F 30/17

(57) ABSTRACT

A manufacturing system design verification device includes a design information model, a design information input part, a verification logic storage part, and a design information verification part. The design information model is a framework integrating and expressing design information. The design information is inputted to the design information input part. The design information input part converts the design information into an expression described a resource description language with reference to the design information model. The verification logic storage part stores a verification logic including a group of a query described in a query language corresponding to the resource description language and an expected result. The design information verification part includes a query execution engine performing the query on the expression an returning an execution result and a comparison engine comparing the execution result with the expected result and returning a verification result.

### TECHNICAL FIELD

The present disclosure relates to a manufacturing system design verification device.

### BACKGROUND ART

A plural types of design such as a mechanical design, an electrical design, a control design are performed when a manufacturing system is designed. Known is a technique for verifying adequacy of design information of a manufacturing system when such a manufacturing system is designed. For example, in a technique described in Patent Document 1, design information such as a mechanical CAD drawing and a control program is inputted to a dedicate device simulator, and adequacy of the design information of a manufacturing system is verified by simulating a whole operation of the manufacturing system by the dedicate device simulator.

### PRIOR ART DOCUMENTS

### Patent Documents

Patent Document 1: Japanese Patent Application Laid-Open No. 2015-225419

### SUMMARY

### Problem to be Solved by the Invention

However, in a conventional verification of adequacy of manufacturing system design information using the simulation, only some design information such as a mechanical CAD drawing and a control program can be inputted as the manufacturing system design information to the simulator. Thus, contents which can be verified are limited.

The present disclosure is made in view of this problem. An object of the present disclosure is to provide a manufacturing system design verification device capable of broadening design information which can be verified.

### Means to Solve the Problem

A manufacturing system design verification device includes a design information model, a design information input part, a verification logic storage part, and a design information verification part. The design information model is a framework integrating and expressing design information. The design information is inputted to the design information input part. The design information input part converts the design information into an expression described in a resource description language with reference to the design information model. The verification logic storage part stores a verification logic including a group of a query described in a query language corresponding to the resource description language and an expected result. The design information verification part includes a query execution engine performing the query on the expression and returning an execution result and a comparison engine comparing the execution result with the expected result and returning a verification result.

### Effects of the Invention

According to the present disclosure, the design information is converted into the expression described in the resource description language with reference to a design information model as the framework integrating and expressing the design information, and the verification result is returned based on the expression. Thus, the design information of various designs such as a process design, a mechanical design, an electrical design, and a control design can be inputted to the manufacturing system design verification device. Accordingly, a type of the design information which can be verified by the manufacturing system design verification device can be broadened.

These and other objects, features, aspects and advantages of the present disclosure will become more apparent from the following detailed description and the accompanying drawings.

### BRIEF DESCRIPTION OF DRAWINGS

FIG. 1 A block diagram schematically illustrating a hardware configuration of a manufacturing system design verification device according to an embodiment 1.

FIG. 2 A block diagram schematically illustrating a functional configuration of the manufacturing system design verification information according to the embodiment 1.

FIG. 3 A flow chart illustrating a flow of a process relating to an input of manufacturing system design information performed by the manufacturing system design verification device according to the embodiment 1.

FIG. 4 A flow chart illustrating a flow of a process relating to a verification of design information performed by the manufacturing system design verification device according to the embodiment 1.

FIG. 5 A diagram describing an example of a verification of design information performed by the manufacturing system design verification device according to the embodiment 1.

FIG. 6 A diagram illustrating an example of a screen displayed on the manufacturing system design verification device according to the embodiment 1.

FIG. 7 A block diagram schematically illustrating a functional configuration of a manufacturing system design verification device according to an embodiment 2.

FIG. 8 A diagram illustrating an example of a verification item template inputted to a manufacturing system design verification device according to the embodiment 2.

FIG. 9 A diagram illustrating an example of an internal specification inputted to the manufacturing system design verification device according to the embodiment 2.

FIG. 10 A flow chart illustrating a flow of a process relating to an input of a verification item template and generation and storage of a verification logic performed by the manufacturing system design verification device according to the embodiment 2.

FIG. 11 A diagram describing an example of a verification relating to an external specification performed by the manufacturing system design verification device according to the embodiment 2.

FIG. 12 A block diagram schematically illustrating a functional configuration of a manufacturing system design verification device according to an embodiment 3.

FIG. 13 A diagram illustrating an example of an operation specification inputted to the manufacturing system design verification device according to the embodiment 3.

FIG. 14 A flow chart illustrating a flow of a process relating to a verification of a control program using the operation specification performed by the manufacturing system design verification device according to the embodiment 3.

FIG. 15 A diagram describing an example of a verification performed by the manufacturing system design verification device according to the embodiment 3.

FIG. 16 A block diagram schematically illustrating a functional configuration of a part of a manufacturing system design verification device according to an embodiment 4.

FIG. 17 A flow chart illustrating a flow of a process relating to acquirement of a design index and generation of a verification logic performed by the manufacturing system design verification device according to the embodiment 4.

### DESCRIPTION OF EMBODIMENT(S)

### Embodiment 1

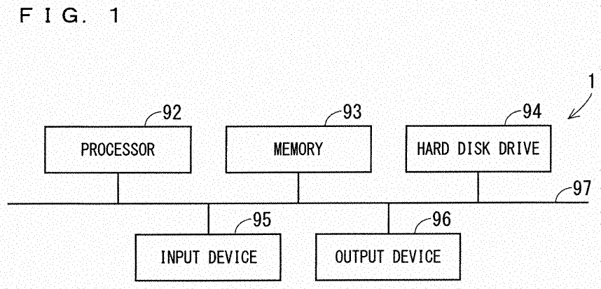

FIG. 1 is a block diagram schematically illustrating a hardware configuration of a manufacturing system design verification device according to an embodiment 1.

As illustrated in FIG. 1, a manufacturing system design verification device 1 according to the embodiment 1 includes a processor 92, a memory 93, a hard disk drive 94, an input device 95, an output device 96, and a system bus 97.

The processor 92 is a central processing unit (CPU), a graphics processing unit (GPU), or a digital signal processor (DSP), for example. The memory 93 is a random access memory (RAM) or a read-only memory (ROM), for example. The hard disk drive 94 may be replaced with an auxiliary storage device other than the hard disk drive 94. For example, the hard disk drive 94 may be replaced with a solid state drive (SSD) or a RAM disk, for example. The input device 95 is a keyboard, a pointing device, a microphone, a scanner, a camera, a communication interface, or a sensor, for example. The output device 96 is a display, a lamp, a speaker, or a communication interface, for example.

The system bus 97 connects the processor 92, the memory 93, the hard disk drive 94, the input device 95, and the output device 96 so that they can perform communication with each other.

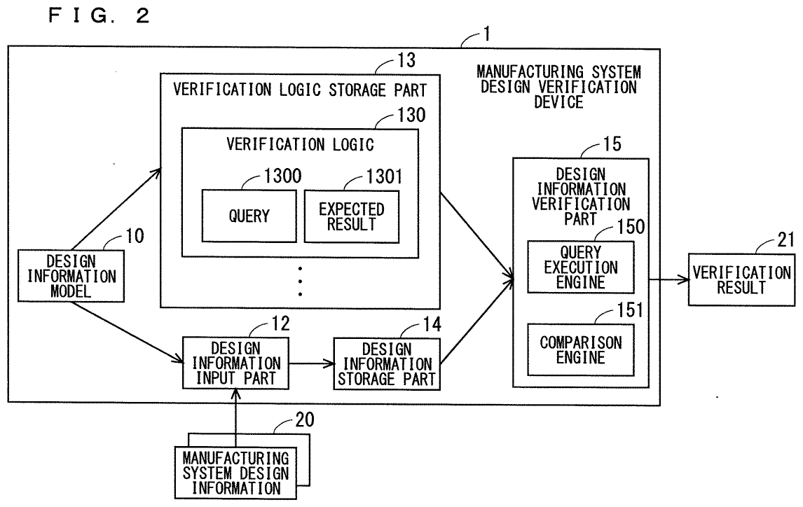

FIG. 2 is a block diagram schematically illustrating a functional configuration of the manufacturing system design verification device according to the embodiment 1.

As illustrated in FIG. 2, the manufacturing system design verification device 1 includes a design information model 10, a design information input part 12, a verification logic storage part 13, a design information storage part 14, and a design information verification part 15. These elements are constituted by the processor 92 executing a program loaded from the hard disk drive 94 to the memory 93. Some or all of these elements may be constituted by hardware which does not execute a program.

Manufacturing system design information 20 is inputted to the manufacturing system design verification device 1. The manufacturing system design verification device 1 outputs a verification result 21 of the manufacturing system design information 20.

The manufacturing system design information 20 indicates contents of a design of a manufacturing system for manufacturing a product. The manufacturing system design information 20 includes design information indicating contents of a design such as a process design, a mechanical design, an electrical design, and a control design included in the design of the manufacturing system. The design information indicating the contents of the design is outputted from a design tool used in the design.

Partial information constituting the design information is referred to as a design item hereinafter.

The design information model 10 is a framework integrating and expressing the design information. The design information model 10 defines a regulation for expressing the design information by a specific expression form, thereby integrating and expressing the design information. The defined regulation includes a definition of a class and a definition of a relationship between the design items. The definition of the class classifies the design items included in the design information. The definition of the relationship indicates how a design item and the other design item relating to the design item are related to each other.

The manufacturing system design information 20 is inputted to the design information input part 12. Accordingly, the design information included in the manufacturing system design information 20 is inputted to the design information input part 12.

The design information input part 12 converts the inputted design information into an expression described in a resource description language with reference to the design information model 10. At that time, the design information input part 12 converts the design information into an expression described in a resource description language using a class and a relationship defined by the referred design information model 10. The resource description language is an AutomationML, a Resource Description Framework (RDF), for example. The expression described in the resource description language is referred to as a design information resource hereinafter.

Considered herein is a case where a class of “process” and “device” and a relationship of “device used in process” are defined by the design information model 10. In this case, the design information resource includes “process A” and “device B” as an instance of the class of “process” and “device”, and when there is a relationship of “device used in process” between “process A” and “process B”, the design information resource expresses that “device used in process A is device B”.

The design information storage part 14 stores both the inputted design information and a design information resource obtained by converting the design information. At that time, the design information storage part 14 stores the design information and the design information resource in a design information database (DB).

The verification logic storage part 13 stores at least one verification logic 130. At that time, the verification logic storage part 13 stores at least one verification logic 130 in a verification item DB. At least one verification logic 130 which has been stored is used for verifying compliance of the design information. Each verification logic 130 includes a group of a query 1300 and an expected result 1301.

The query 1300 is at least one query. The query 1300 is described in a query language corresponding to the resource description language described above. The query language is SPARQL, for example. The query 1300 is a query obtaining information included in the design information using the class and the relationship defined by the design information model 10. For example, the query 1300 is a query obtaining a value of a specific design item or a query checking whether or not there is a specific relationship between two design items.

The expected result 1301 is compared with an execution result of the query 1300 paired with the expected result 1301. The expected result 1301 is expressed by a function definition outputting a truth-value taking the execution result of the query 1300 as an argument using a programming language. Accordingly, the expected result 1301 expresses a limitation which should be satisfied by the execution result of the query 1300.

The design information verification part 15 performs verification whether or not the design information satisfies the verification logic 130 on the verification logic 130 stored in the verification logic storage part 13 and the design information resource stored in the design information storage part 14. The design information verification part 15 includes a query execution engine 150 and a comparison engine 151. The query execution engine 150 executes the query 1300 described in a query description language on the design information resource described in the resource description language, and returns the execution result of the query 1300. The query execution engine 150 is a SPARQL execution engine, for example. The comparison engine 151 compares the returned execution result of the query 1300 with the expected result 1301, and returns a verification result. At that time, the comparison engine 151 applies a function as the expected result 1301 to the execution result of the query 1300, and returns a verification result. Accordingly, the design information verification part 15 outputs the verification result for each verification logic 130. The outputted verification result is given by true or false, and is included in the verification result 21 outputted by the manufacturing system design verification device 1. Accordingly, the design information verification part 15 executes the verification logic 130, thereby being able to mechanically confirm compliance of the manufacturing system design information 20.

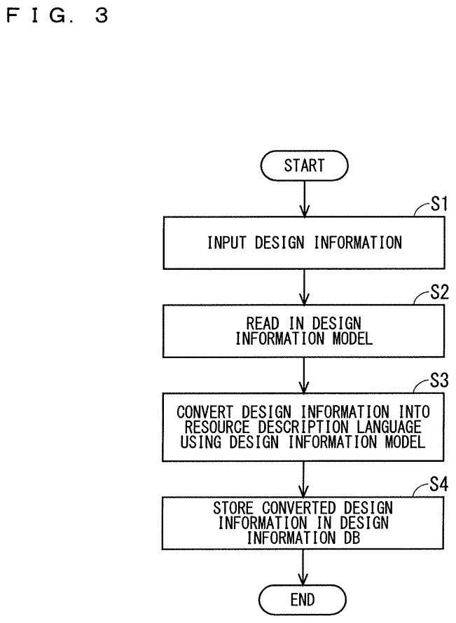

FIG. 3 is a flow chart illustrating a flow of a process relating to an input of manufacturing system design information performed by the manufacturing system design verification device according to the embodiment 1.

The design information input part 12 executes Steps S1 to S4 illustrated in FIG. 3.

In Step S1, the design information included in the manufacturing system design information 20 is inputted to the design information input part 12.

In subsequent Step S2, the design information input part 12 reads in the design information model 10.

In subsequent Step S3, the design information input part 12 converts the design information inputted using the design information model 10 which has been read into the design information resource as the expression described in the resource description language.

In subsequent Step S4, the design information input part 12 stores the design information and the design information resource in the design information storage part 14.

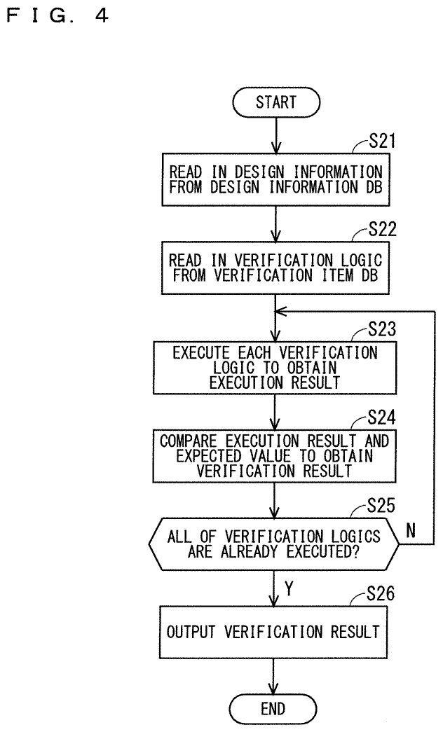

FIG. 4 is a flow chart illustrating a flow of a process relating to a verification of the design information performed by the manufacturing system design verification device according to the embodiment 1.

The design information verification part 15 executes Steps S21 to S26 illustrated in FIG. 4.

In Step S21, the design information verification part 15 reads in the design information resource from design information DB constituted by the design information storage part 14.

In subsequent Step S22, the design information verification part 15 reads in at least one verification logic 130 from the verification item DB constituted by the verification logic storage part 13.

In subsequent Step S23, the query execution engine 150 executes each verification logic 130 and obtains the execution result of the query 1300 included in each verification logic 130. At that time, the query execution engine 150 executes the query 1300 included in each verification logic 130 on the design information resource which has been read to obtain the execution result of the query 1300.

In subsequent Step S24, the comparison engine 151 compares the obtained execution result with the expected value as the expected result 1301 included in each verification logic 130 to obtain the verification result.

In subsequent Step S25, the design information verification part 15 determines whether or not all of at least one verification logic 130 has been executed. When all of at least one verification logic 130 have been executed, the design information verification part 15 proceeds with the process to Step S26, and when they have not been executed, the design information verification part 15 returns the process to Step S23. When the process is returned to Step S23, the comparison engine 151 obtains, in Step S23, the verification result for the verification logic 130 whose verification result has not been obtained.

In Step S26, the design information verification part 15 outputs the verification result 21 including the verification result obtained for at least one verification logic 130.

According to the embodiment 1, the design information is converted into the expression described in the resource description language with reference to the design information model 10 as the framework integrating and expressing the design information, and the verification result is returned based on the expression. Thus, the design information of various designs such as a process design, a mechanical design, an electrical design, and a control design can be inputted to the manufacturing system design verification device 1. Accordingly, a type of the design information which can be verified by the manufacturing system design verification device 1 can be broadened.

According to the embodiment 1, the design information verification part 15 provides a system capable of formally expressing contents to be verified and executing verification by a computer. Accordingly, compliance of the manufacturing system design information 20 can be mechanically verified.

Thus, according to the embodiment 1, cost in a stage of the design of the manufacturing system can be reduced.

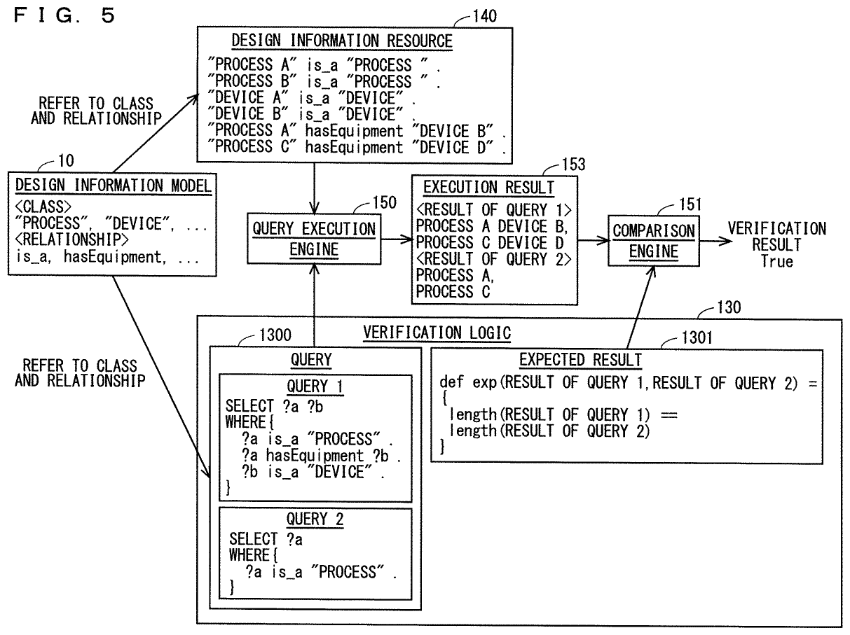

FIG. 5 is a diagram illustrating an example of a verification of the design information performed by the manufacturing system design verification device according to the embodiment 1.

In the example described in FIG. 5, confirmed is that there is a device achieving all of the processes included in the design information, thus it is verified whether or not the design information includes a defect. Accordingly, in the example described by FIG. 5, a state where the design information has compliance is a state where there is a device achieving all of the processes included in the design information.

The design information model 10 includes a definition of the class of the design item and a definition of a relationship between the design items or between the classes. The design information resource 140 is obtained when the design information input part 12 converts the design information into the expression described in the resource description language using the definition of the class and the relationship. The design information resource 140 is described in an RDF form, for example, and takes a form of a list of three-piece group including two elements as the design item or the class and one relationship. In the example described in FIG. 5, “is_a relationship” in a first line in the design information resource 140 expresses that “process A” belongs to “process” class. Moreover, “hasEquipment relationship” in a fifth line in the design information resource 140 expresses that “device B” achieves “process A”.

The verification logic 130 includes the query 1300 and the expected result 1301. The query 1300 is at least one query, and is described by SPARQL as the query language using the class and the relationship defined by the design information model 10. The expected result 1301 may be a simple expected value, or may also be a procedure described in the programming language. When the expected result 1301 is the procedure described in the programming language, the expected result 1301 can describe a limitation which should be satisfied by an execution result 153 of the query 1300 even in a case where the query 1300 is a plurality of queries.

Described herein is a method of constituting the verification logic 130, the query 1300, and the expected result 1301.

In the example illustrated in FIG. 5, the contents to be verified are that “there is device achieving all of processes included in design information”. The contents to be verified can be expressed by preparing the query 1300 including the query extracting all of the processes and the query extracting all of the processes expressed by the device, and determining that a state where the number of processes extracted to the former query is equal to the number of processes extracted by the latter query is the expected result 1301. Prepared in the example described in FIG. 5 is the query 1300 including “query 1” obtaining a group of processes and a device relating to the processes and “query 2” obtaining a list of the processes. The expected result 1301 has a function evaluating whether or not a magnitude of an execution result of “query 1” is a magnitude of an execution result of “query 2” are equal to each other.

The design information verification part 15 makes the query execution engine 150 execute the verification logic 130 on the design information resource 140 to verify the design information. Accordingly, the execution result 153 of each query 1300 can be obtained. The execution result 153 of each query 1300 and the expected result 1301 are inputted to the comparison engine 151. The comparison engine 151 applies the function as the expected result 1301 inputted to the inputted execution result 153 of each query 1300, thereby returning a truth-value provided by “True” or “False”. A state there the returned truth-value is provided by “True” indicates that the execution result 153 of each query 1300 satisfies the expected result 1301. In the meanwhile, a state there the returned truth-value is provided by “false” indicates that the execution result 153 of each query 1300 does not satisfy the expected result 1301. In the example described in FIG. 5, the magnitude of the execution result of “query 1” and the magnitude of the execution result of “query 2” is the same, that is 2, thus the returned truth-value is provided by “True”.

In the example described in FIG. 5, when the design information resource 140 lacks [“process C” hasEquipment “device D”], the execution result of “query 1” is only “process A, device B”, thus the magnitude of the execution result of “query 1” and the magnitude of the execution result of “query 2” are different from each other, and the returned truth-value is provided by “False”. Accordingly, the design information includes a defect in this case.

A method of constituting the verification logic 130, the query 1300, and the expected result 1301 different from the method of constituting the verification logic 130, the query 1300, and the expected result 1301 described above may also be adopted.

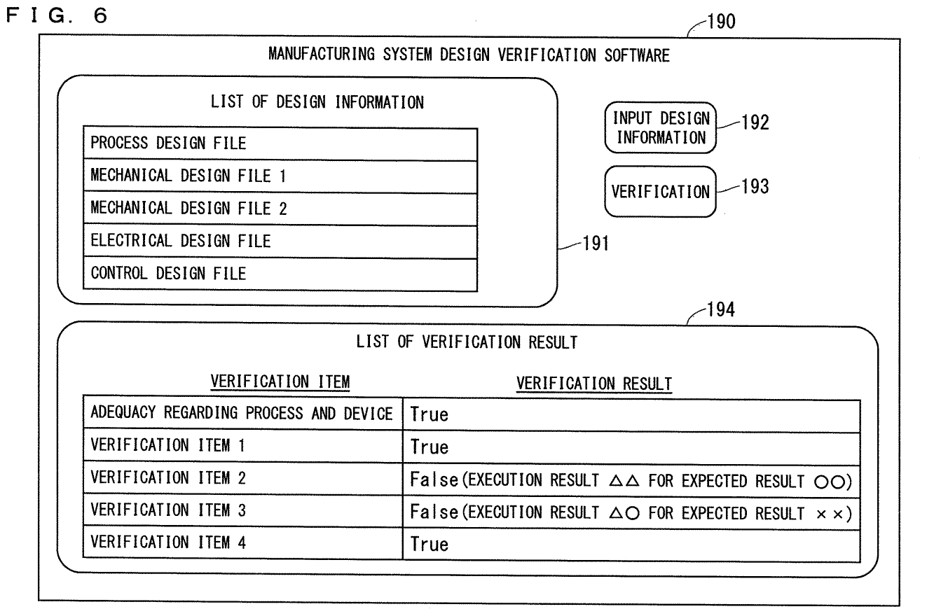

FIG. 6 is a diagram illustrating an example of a screen displayed on the manufacturing system design verification device according to the embodiment 1.

A screen 190 illustrated in FIG. 6 is displayed on a display as an output device 96. The screen 190 is displayed by software achieving a function of inputting and verifying the design information in the manufacturing system design verification device 1.

A design file as design information stored in the design information DB is listed and displayed in a “design information list” area 191 in the screen 190. When the screen 190 is displayed, a design file is selected on a file selection dialog displayed upon pressing a “design information input” button 192, thus design information as a selected design file can be additionally stored in the design information storage part 14 in accordance with a flow of a process illustrated in FIG. 3. When the display 190 is displayed, a “verification” button 193 is pressed, thus the design information stored in the design information storage part 14 can be verified in accordance with a flow of a process illustrated in FIG. 4. A result of the verification is displayed in a “verification result list” area 194. A result of the verification is displayed for each verification item corresponding to one verification logic 130 in the “verification result list” area 194. The result of each verification is provided by “True” or “False”. When the result of the verification is provided by “False”, a difference of the execution result from the expected result is indicated as a cause thereof.

The design information verification part 15 can perform verification at an optional timing on verification logic 130 stored in the verification logic storage part 13 and the design information stored in the design information storage part 14. For example, the design information verification part 15 can perform verification when a user presses the “verification” button 193, and can also perform verification when the design information is updated, thus can perform verification when the verification logic 130 is updated in accordance with the update of the design information model 10.

A user can freely select the verification item verified by the manufacturing system design verification device 1. Accordingly, the verification can also be performed only on an optional number of verification logics 130 selected by the user from the verification logic 130 stored in the verification logic storage part 13. As a method of making the user select the verification item, for example, it is also applicable to display a setting dialog and make the user select the verification item by the displayed setting dialog.

A method of outputting the verification result 21 is not limited. For example, the verification result 21 can be displayed for the user via a graphical user interface (GUI). The user can be notified of the verification result 21 by E-mail.

### Embodiment 2

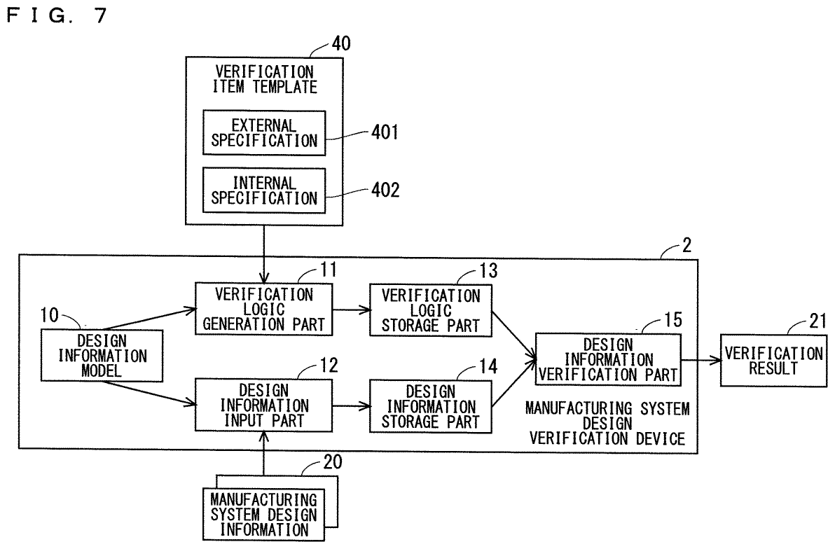

FIG. 7 is a block diagram schematically illustrating a functional configuration of a manufacturing system design verification device according to an embodiment 2.

Described hereinafter is a point that a manufacturing system design verification device 2 according to the embodiment 2 in FIG. 7 is different from the manufacturing system design verification device 1 according to the embodiment 1 in FIG. 1. With regard to the point not described hereinafter, a configuration similar to that adopted in the manufacturing system design verification device 1 is also adopted in the manufacturing system design verification device 2.

As illustrated in FIG. 7, the manufacturing system design verification device 2 further includes a verification logic generation part 11.

A verification item template 40 is inputted to the verification logic generation part 11. The verification logic generation part 11 generates the verification logic 130 based on the inputted verification item template 40.

The verification item template 40 includes an input column for at least one of an external specification 401 and an internal specification 402. Thus, the user inputs at least one of the external specification 401 and the internal specification 402 in the input column, thereby being able to describe at least one of the external specification 401 and the internal specification 402 in the verification item template 40. A specification described in the verification item template 40 is an item to be verified.

The external specification 401 indicates a specification value of a manufacturing system. The specification value of the manufacturing system is a size of a manufacturing system, a weight of a manufacturing system, a consumption power of a whole manufacturing system, and a thermal capacity of a whole manufacturing system, for example.

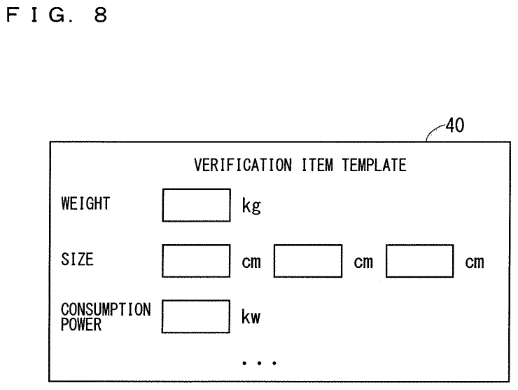

FIG. 8 is a diagram illustrating an example of a verification item template inputted to the manufacturing system design verification device according to the embodiment 2.

The verification item template 40 illustrated in FIG. 8 includes an input column for the weight of the manufacturing system, the size of the manufacturing system, and the consumption power of the whole manufacturing system as the input column for the external specification 401.

The internal specification 402 indicates internal design information of the manufacturing system used at a time of designing the manufacturing system. The internal design information of the manufacturing system is a connection relationship table indicating a connection relationship between a programmable logic controller (PLC) and a contact point of each apparatus or a component table as a list of commercial products used for constituting the manufacturing system, for example.

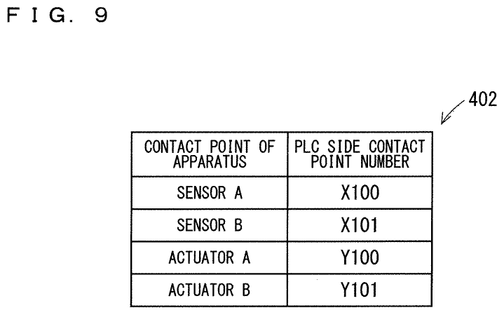

FIG. 9 is a diagram illustrating an example of an internal specification inputted to the manufacturing system design verification device according to the embodiment 2.

The internal specification 402 illustrated in FIG. 9 is the connection relationship table described above. The connection relationship table indicates that “sensor A” is connected to a PLC side contact point having a PLC side contact point number of “X100”. When the connection relationship table is described in the verification item template 40, each item of the connection relationship table serves as the input column.

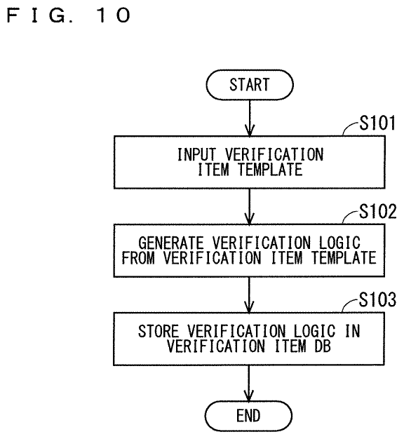

FIG. 10 is a flow chart illustrating a flow of a process relating to an input of a verification item template and generation and storage of a verification logic performed by the manufacturing system design verification device according to the embodiment 2.

The verification logic generation part 11 executes Steps S101 to S103 illustrated in FIG. 10.

The verification item template 40 is inputted to the verification logic generation part 11 in Step S101. A least one of the external specification 401 and the internal specification 402 is inputted to the input column of the inputted verification item template 40. Thus, at least one of the external specification 401 and the internal specification 402 is described in the inputted verification item template 40 by the user.

The verification logic generation part 11 generates the verification logic 130 from the inputted verification item template 40 in subsequent Step S102. The generated verification logic 130 includes a group of the query 1300 and the expected result 1301 in the manner similar to the embodiment 1. The query 1300 obtains a value included in the design information and presence or absence of a relationship included in the design information. The expected result 1301 is a function comparing the value inputted to the input column of the verification item template 40 with the execution result of the query 1300. The query 1300 corresponding to each input column of the verification item template 40 is basically prepared when the verification logic 130 is generated, and the value in the function as the expected result 1301 changes in accordance with each input column.

In Step S103, the verification logic generation part 11 stores the generated verification logic 130 in the verification item DB constituted by the verification logic storage part 13.

According to the embodiment 2, the item which the user would like to verify is described in the verification item template 40, thus the design can be verified for the plurality of verification items regarding the external specification 401 and the internal specification 402, for example.

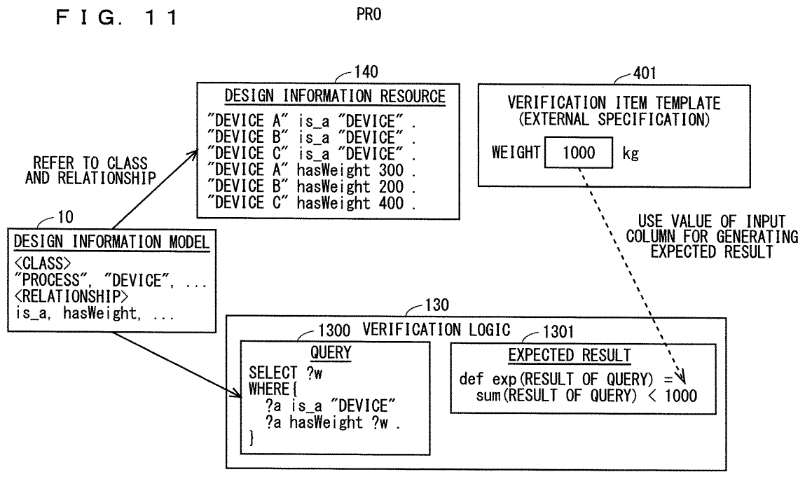

FIG. 11 is a diagram illustrating an example of a verification relating to an external specification performed by the manufacturing system design verification device according to the embodiment 2.

In the example described by FIG. 11, it is verified whether or not a weight of the manufacturing system is equal to or smaller than that of the manufacturing system inputted to the input column of the verification item template 40. In the example described by FIG. 11, the design information resource 140 expresses a weight of a device constituting the manufacturing system using hasWeight relationship. The external specification 401 inputted to the input column of the verification item template 40 is inputted to the verification logic generation part 11.

The verification logic generation part 11 generates the verification logic 130 from the inputted external specification 401 in accordance with the flow of the processes illustrated in FIG. 10. The query 1300 included in the generated verification logic 130 is prepared for each input column of the verification item template 40. In the example described by FIG. 11, the query 1300 obtains the weight of the device constituting the manufacturing system. The expected result 1301 included in the verification logic 130 is generated as a function comparing whether or not the execution result of the query 1300, that is to say, a total weight of the device constituting the manufacturing system is smaller than the weight of the manufacturing system inputted to the input column for the external specification 401. Accordingly, the verification logic generation part 11 can generate the verification logic 130 from the external specification 401.

In the similar manner, the verification logic generation part 11 can also generate the verification logic 130 from the internal specification 402. When the verification logic 130 is generated from the internal specification 402, for example, it is verified whether or not a wiring is performed in the design information in accordance with the connection relationship table inputted to the input column regarding the internal specification 402 of the verification item template 40. In this case, a query obtaining a contact point of an apparatus to which each PLC terminal included in the manufacturing system is connected can be considered as the query 1300 included in the verification logic 130. A function having a process of comparing the execution result of the query 1300 and the connection relationship table can be considered as the expected result 1301 included in the verification logic 130.

In the flow of the process illustrated in FIG. 10, the verification logic 130 generated from the verification item template 40 is additionally stored in the verification logic storage part 13. However, the verification logic 130 already stored in the verification logic storage part 13 based on the verification item template 40 can be corrected or deleted.

### Embodiment 3

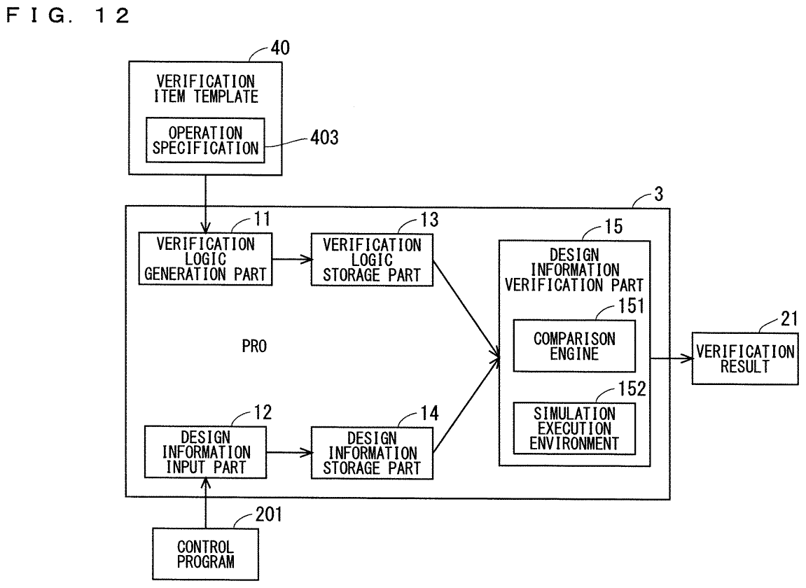

FIG. 12 is a block diagram schematically illustrating a functional configuration of a manufacturing system design verification device according to an embodiment 3.

Described hereinafter is a point that a manufacturing system design verification device 3 according to the embodiment 3 in FIG. 12 is different from the manufacturing system design verification device 1 according to the embodiment 1 in FIG. 1. With regard to the point not described hereinafter, a configuration similar to that adopted in the manufacturing system design verification device 1 is also adopted in the manufacturing system design verification device 3.

The manufacturing system design verification device 3 can perform verification described above, and can also perform verification different from the verification described above when the manufacturing system design information 20 includes a control program 201. When the manufacturing system design information 20 includes the control program 201, the control program 201 is inputted to the design information input part 12. The control program 201 is generated in a control design included in a design of the manufacturing system.

As illustrated in FIG. 12, the manufacturing system design verification device 3 further includes a verification logic generation part 11.

A verification item template 40 is inputted to the verification logic generation part 11.

The verification item template 40 includes the input column for an operation specification 403. A user inputs the operation specification 403 to the input column, thereby being able to describe the operation specification 403 in the verification item template 40. The operation specification 403 described in the verification item template 40 is an item to be verified.

The operation specification 403 expresses an operation of a manufacturing system. The operation specification 403 is a device constituting a manufacturing system or a timing chart in which an operation timing of an apparatus is described, for example.

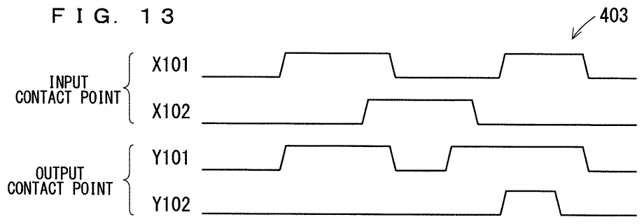

FIG. 13 is a diagram illustrating an example of an operation specification inputted to the manufacturing system design verification device according to the embodiment 3.

The operation specification 403 illustrated in FIG. 13 is a timing chart. The timing chart expresses a time change of values of an input contact point having a PLC side contact point number starting from “X” of the PLC and an output contact point having a PLC side contact point number starting from “Y” thereof. In the operation specification 403 illustrated in FIG. 13, the value changes between two values of an ON value corresponding to “ON” and an OFF value corresponding to “OFF” The value can change between three values. The value may be an analog value. When the operation specification 403 is a timing chart, the timing chart is inputted to the input column of the verification item template 40.

The verification logic generation part 11 sets the operation specification 403 to the verification logic 130 stored in the verification logic storage part 13.

As illustrated in FIG. 12, the design information verification part 15 includes a simulation execution environment 152. When the control program 201 is input to the design information input part 12, the simulation execution environment 152 simulatively executes the control program 201 using information included in the operation specification 403, and outputs an execution result. When the operation specification 403 is a timing chart as illustrated in FIG. 13, the simulation execution environment 152 reads in a combination of a time change of the value of the input contact point and the control program 201 included in the timing chart, and simulatively executes the control program 201 using the combination of the time change of the value of the input contact point which has been read to return the combination of the time change of the value of the output contact point.

The comparison engine 151 compares the outputted execution result with the expected result included in the operation specification 403, and returns the verification result.

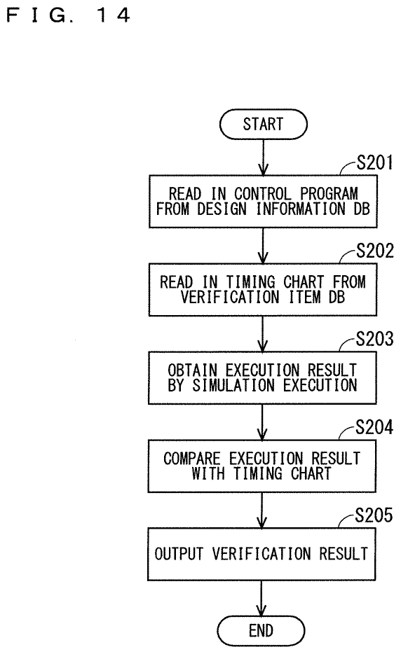

FIG. 14 is a flow chart illustrating a flow of a process relating to a verification of a control program using the operation specification performed by the manufacturing system design verification device according to the embodiment 3.

The design information verification part 15 executes Steps S201 to S205 illustrated in FIG. 14.

When the execution from Steps S201 to S205 is started, the timing chart as the verification logic 130 is assumed to be already stored in the verification logic storage part 13. The control program 201 as the design information of the control design is assumed to be already stored in the design information storage part 14.

In Step S201, the design information verification part 15 reads in the control program 201 as the design information from the design information DB constituted by the design information storage part 14.

In subsequent Step S202, the design information verification part 15 reads in the timing chart as the verification logic 130 from the verification item DB constituted by the verification logic storage part 13.

In subsequent Step S203, the simulation execution environment 152 simulatively executes the control program 201 to obtain the execution result based on the control program 201 and the timing chart which have been read. The obtained execution result includes a time change of the value of the output contact point of the PLC.

In subsequent Step S204, the comparison engine 151 compares the time change of the value of the output contact point of the PLC included in the obtained execution result with the time change of the value of the output contact point of the PLC included in the obtained timing chart to return the verification result.

In Step S205, the design information verification part 15 outputs the verification result 21. The outputted verification result 21 includes the verification result returned in Step S204.

According to the embodiment 3, it can be mechanically verified whether or not the operation achieved by the control program 201 coincides with the operation expressed by the timing chart as the operation specification 403.

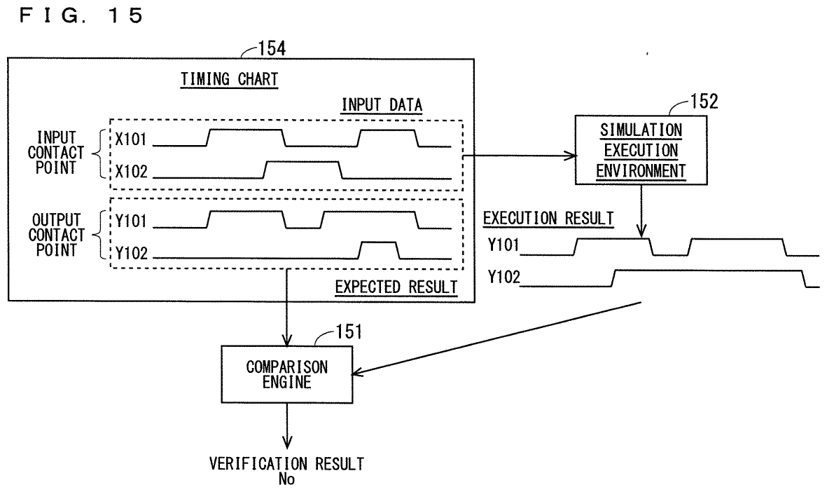

FIG. 15 is a diagram illustrating an example of a verification performed by the manufacturing system design verification device according to the embodiment 3.

In the example described in FIG. 15, a timing chart 154 is inputted to the input column for the operation specification 403 of the verification item template 40 by the user. The time change of the value of the input contact point of the PLC included in the timing chart 154 serves as input data inputted to the simulation execution environment 152. The time change of the value of the output contact point of the PLC included in the timing chart 154 serves as the expected result 1301 inputted to the comparison engine 151.

The time change of the value of the input contact point of the PLC is inputted to the simulation execution environment 152. The simulation execution environment 152 outputs the time change of the value of the output contact point of the PLC as the execution result. The time change of the value of the output contact point of the outputted PLC is inputted to the comparison engine 151. The comparison engine 151 compares the time change of the value of the output contact point of the PLC inputted from the simulation execution environment 152 with the time change of the value of the output contact point of the PLC as the expected result 1301 to return the verification result. At that time, the comparison engine 151 determines that the verification result is “No” by reason that the time change of the value of the output contact point having the PLC side contact point number of “Y102” is different from the time change of the value of the output contact point having the same PLC side contact point number as the PLC side contact point number.

The verification result obtained in this manner includes information of the time change of the value of the output contact point of the PLC. Thus, the verification result can be illustrated on the GUI as the timing chart. Accordingly, the user can easily compare the time change of the values of the output contact point of the PLC.

### Embodiment 4

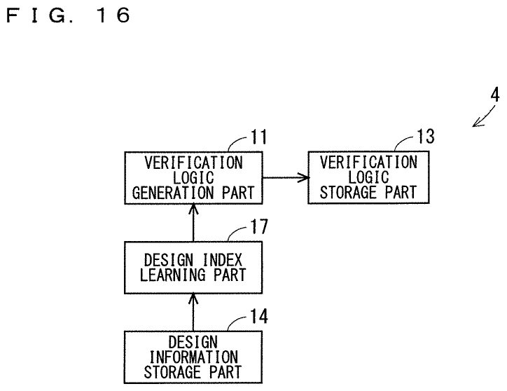

FIG. 16 is a block diagram schematically illustrating a functional configuration of a part of a manufacturing system design verification device according to an embodiment 4.

Described hereinafter is a point that a manufacturing system design verification device 4 according to the embodiment 4 in FIG. 16 is different from the manufacturing system design verification device 1 according to the embodiment 1 in FIG. 1. With regard to the point not described hereinafter, a configuration similar to that adopted in the manufacturing system design verification device 1 is also adopted in the manufacturing system design verification device 4.

In the manufacturing system design verification device 4, the design information storage part 14 can accumulate a plural pieces of design information relating to the manufacturing system. The design information storage part 14 stores the design information inputted to the design information input part 12 and includes it in the accumulated design information. Accordingly, the design information storage part 14 can accumulate the design information with the design information of a past design.

As illustrated in FIG. 16, the manufacturing system design verification device 4 further includes a design index learning part 17.

The design index learning part 17 learns a design index from the plural pieces of design information accumulated in the design information storage part 14. The learned design index indicates a preferable design. The design index indicates a relationship of two design items included in design information in the manufacturing system design information 20. The two design items are two design items in which when a value of one of the two design items is determined, a value of the other one of the two design items is determined. The two design items are the number of contact points of the PLC and a size of a control board, for example. When the number of contact points of the PLC is determined, the size of the control board is determined, thus the number of contact points of the PLC and the size of the control board can be the two design items.

The verification logic generation part 11 generates the verification logic 130 from the learned design index.

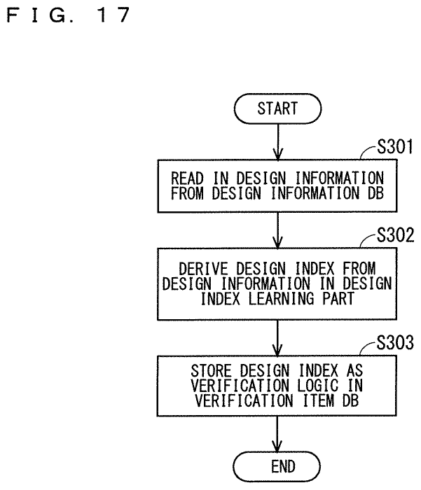

FIG. 17 is a flow chart illustrating a flow of a process relating to acquirement of the design index and generation of the verification logic performed by the manufacturing system design verification device according to the embodiment 4.

The verification logic generation part 11 and the design index learning part 17 execute Steps S301 to S303 illustrated in FIG. 17.

In Step S301, the design index learning part 17 reads in the design information from the design information DB constituted by the design information storage part 14.

In subsequent Step S302, the design index learning part 17 derives the design index from the design information which has been read. The design index is expressed by a function in which a value of the other design item is returned when a value of a certain design item is inputted. For example, when a design index relating to two design items A and B are expressed by a function f, the function f returns a value f(a) of the design item B when a value a of the design item A is inputted. The returned value f(a) is a recommended value of the design item B. The function can be obtained by a statistical method of inputting a value of a design item included in known design information or a mechanical learning, for example.

In subsequent Step S303, the verification logic generation part 11 generates the verification logic 130 from the design index, and stores the generated verification logic 130 in the verification item DB constituted by the verification logic storage part 13. The stored verification logic 130 is a group of the query 1300 and the expected result 1301 in the manner similar to the embodiment 1. The query 1300 obtains values of certain two design items from the design information. The expected result 1301 is a function of comparing the execution result of the query 1300 with the design index.

According to the embodiment 4, the design index is learned from the accumulated design information, and the verification logic 130 is generated from the learned design index. The design information is verified based on the generated verification logic 130. Accordingly, it can be verified whether or not the design information is design information deviating from the design information of the other plurality of designs.

Each embodiment can be arbitrarily combined, or each embodiment can be appropriately varied or omitted.

Although the present disclosure is described in detail, the foregoing description is in all aspects illustrative and does not restrict the disclosure. It is therefore understood that numerous modification examples not illustrated can be devised.

### EXPLANATION OF REFERENCE SIGNS

1 Manufacturing system design verification device, 2 manufacturing system design verification device, 3 manufacturing system design verification device, 4 manufacturing system design verification device, 10 design information model, 11 verification logic generation part, 12 design information input part, 13 verification logic storage part, 14 design information storage part, 15 design information verification part, 17 design index learning part, 150 query execution engine, 151 comparison engine, 152 simulation execution environment.

1. A manufacturing system design verification device, comprising:
a processor to execute a program; and
a memory to store the program which, when executed by the processor, performs processes of,
acquiring a design information model as a framework integrating and expressing design information;
inputting the design information and converting the design information into an expression described in a resource description language with reference to the design information model;
storing a verification logic including a group of a query described in a query language corresponding to the resource description language and an expected result; and
performing the query on the expression and returning an execution result and comparing the execution result with the expected result and returning a verification result.

2. The manufacturing system design verification device according to claim 1, further comprising
inputting a verification item template including an input column for at least one of an external specification indicating a specification value of a manufacturing system and an internal specification indicating internal design information of the manufacturing system and generating the verification logic based on the verification item template.

3. The manufacturing system design verification device according to claim 1, further comprising
inputting a verification item template including an input column for an operation specification expressing an operation of a manufacturing system and setting the operation specification to the verification logic, wherein
simulatively executing a control program and outputting an execution result using information included in the operation specification when the control program is inputted, and
comparing the execution result outputted by the simulation execution environment with an expected result included in the operation specification, and returning a verification result.

4. The manufacturing system design verification device according to claim 1, further comprising:
storing the design information and including the design information in the design information which is accumulated;
learning a design index from the design information which is accumulated; and
generating the verification logic from the design index.
